(19) United States
(12) Patent Application Publication
(10) Pub. No.: US 2015/0249708 A1
(43) Pub. Date: Sep. 3, 2015

(54) SYSTEM AND METHOD FOR ASYNCHRONOUS REPLICATION OF A STORAGE IN A COMPUTING ENVIRONMENT

(71) Applicant: CLOUDENDURE LTD., Ramat Gan (IL)

(72) Inventors: Leonid FEINBERG, Ramat HaSharon (IL); Ofir EHRLICH, Netanya (IL); Ofer GADISH, Rishon Lezion (IL); Gil SHAI, Ramat Gan (IL); Ophir SETTER, Ramat Gan (IL)

(73) Assignee: CLOUDENDURE LTD., RAMAT GAN (IL)

(21) Appl. No.: 14/636,233

(22) Filed: Mar. 3, 2015

Related U.S. Application Data
(60) Provisional application No. 61/946,954, filed on Mar. 3, 2014.

(51) Int. Cl. H04L 29/08

(52) U.S. Cl. CPC H04L 67/1095; H04L 67/1097

(57) ABSTRACT

A system and method for method for asynchronous replication of a storage in a computing environment (CE) are provided. The method includes connecting to a primary storage; receiving a content and an address respective of the content; storing, in a designated storage, the content and the address respective of the content; and sending, from the designated storage, the content and the address respective of the content to a secondary storage, wherein the secondary storage is in a secondary CE.

### CROSS-REFERENCE TO RELATED APPLICATIONS

This application claims the benefit of U.S. Provisional Application No. 61/946,954 filed on Mar. 3, 2014, the contents of which are hereby incorporated by reference.

### TECHNICAL FIELD

The present disclosure relates generally to backup and restoration systems for computing environments, and more particularly to backup and restoration systems for computing environments using asynchronous replication.

### BACKGROUND

In recent years, many individuals and businesses have at least some aspect of their activities in the digital world. As the demand for digital storage rises, so too does the demand for creating replications and backups of digital storages. It is often advantageous to keep a replica storage as consistent with the original storage as possible. The replica storage is entirely consistent if it is an exact replica of the original storage at one point in time. If there is no point in time in which the original storage was identical to the current state of the replica storage, then the replica storage is considered inconsistent.

Replicating a storage is typically costly, as it may require an additional storage device as well as system resources used to write content to two storage devices. During replication, data may become corrupted on the replicated storage device, so constant checks may be required to search for inconsistencies, resulting in a taxation of system resources. In some instances, the replicated storage may become full, and is no longer able to store new incoming information which is concurrently written to the primary storage, thereby resulting in further inconsistencies.

It would therefore be advantageous to provide a solution that would overcome the deficiencies of the prior art by ensuring consistency of replica storages.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

The disclosure relates in various embodiments to a method for asynchronous replication of a storage in a computing environment (CE). The method comprises connecting to a primary storage; receiving a content and an address respective of the content; storing, in a designated storage, the content and the address respective of the content; and sending, from the designated storage, the content and the address respective of the content to a secondary storage, wherein the secondary storage is in a secondary CE.

The disclosure also relates in various embodiments to an asynchronous replication system for synchronizing a storage in a computing environment (CE), The system comprises a processing system; a memory containing instructions that, when executed by the processing system, configure the system to: connect to a primary storage; receive a content and an address respective of the content; store, in a designated storage, the content and the address respective of the content; and send, from the designated storage, the content and the address respective of the content to a secondary storage, wherein the secondary storage is in a secondary CE.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a flowchart of a method for asynchronous replication of a storage in a computing environment (CE) according to an embodiment.

FIG. 2 is a schematic illustration of a notification communicatively connected to a secondary storage according to an embodiment.

FIG. 3 is a schematic block diagram illustrating a notification component according to an embodiment.

FIG. 4 is a flowchart illustrating replication according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for asynchronous replication of a storage in a computing environment (CE) provide an efficient and cost-effective solution for a consistent replication of the storage. Accordingly, a primary storage is replicated to a secondary storage in a CE. Thereafter, any changes to data is continuously captured and stored in the secondary storage through a notification component communicating with the primary storage. At any given moment, consistency of the secondary storage, or lack thereof, is known, as is the last consistent state of the secondary storage. Replication may begin at any point in time without disrupting or stopping the work of any applications using the primary storage.

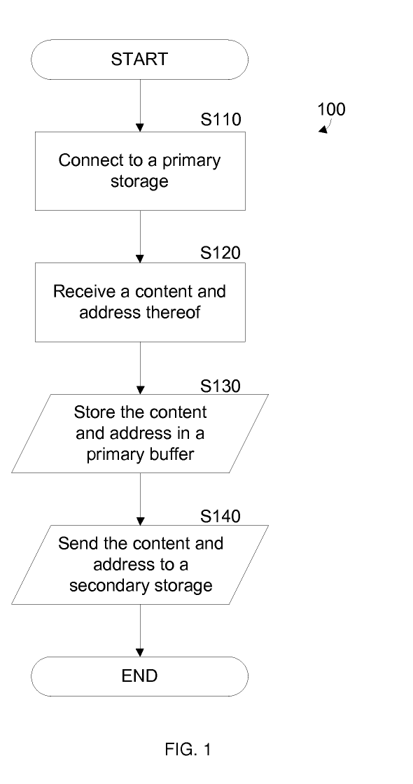

FIG. 1 shows an exemplary and non-limiting flowchart 100 of a method for asynchronous replication of a storage in a computing environment (CE) according to an embodiment. In S110, a connection is performed to a primary storage. The connection may be performed, for example, by a notification component present on a machine that is communicatively connected to the primary storage. In certain embodiments, a notification component may be present on a plurality of machines which are each connected to a primary storage. In certain other embodiments, a notification component may be present on a machine which is connected to a plurality of storages.

In S120, a content and an address respective of the content are received. The content is addressed to be stored on the primary storage. In S130, the content and the address respective of the content are stored in a primary buffer. The primary buffer is typically implemented in a notification component as a memory portion independent of the primary storage. For example, the primary storage may be a hard disk drive (HDD) while the primary buffer is implemented on a non-volatile memory (NVM). In an embodiment, both the primary buffer and the primary storage are components of a single machine. In S140, the content and address respective of the content are sent from the primary buffer to a secondary storage, the secondary storage is in a CE. In certain embodiments, the content and address may be sent to a plurality of secondary storages.

In certain embodiments, a capacity of the primary buffer is determined. Upon determining that the primary buffer is at full capacity, the address respective of the content and a content length are stored in a secondary buffer. In certain embodiments, the secondary buffer stores information on which parts of the storage were modified and when. This can be achieved, for example, by use of a bitmap. For certain embodiments, a plurality of secondary buffers may be implemented. In such embodiments, each secondary buffer may store different data types, each indicative of changes made to the storage.

As will be discussed below the notification component can also be part of the notification component. In some embodiments, the primary buffer and the secondary buffer are implemented on the same physical component such as, for example, a NVM. The address respective of the content is read from the secondary buffer.

Content is retrieved from the primary storage respective of the address and content length. The retrieved content is sent to the secondary storage. This is particularly useful when the primary buffer is full. The secondary storage is required to be consistent with the primary storage as much as possible. A secondary storage is consistent with a primary storage if it is a replica that is consistent with the primary storage. A replica of a primary storage is consistent with the primary storage if the replica is an exact replica of the primary storage as it was at some known point in time. If there is no point in time in which the original storage was identical to the current state of the replica, then the replica storage is considered inconsistent.

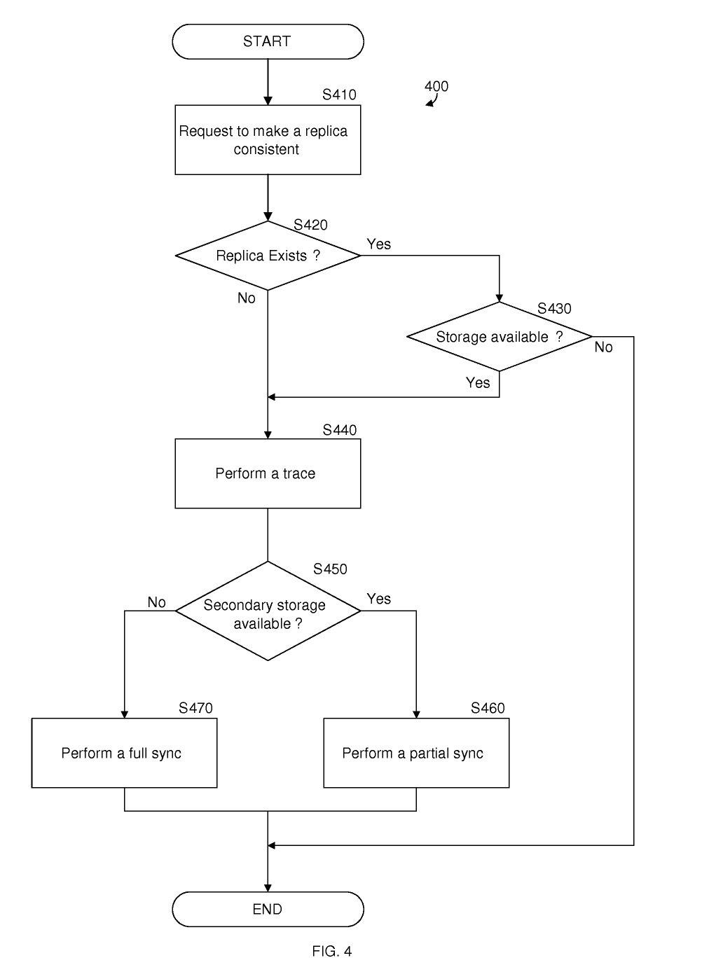

According to certain embodiments, replication is achieved by three processes: a full synchronization (“full sync”), a partial synchronization (“partial sync”), and a trace. An exemplary replication is illustrated in more detail herein below with respect to FIG. 4. In a full sync process, content from the entire primary storage is read sequentially and sent to the secondary storage. Typically, this is performed the first time a primary storage is replicated on a secondary storage, when, for example, there is a probability that changes to the storage were not detected (for example, during a reboot), or when both the primary and secondary buffers are full.

The content that needs to be replicated from the primary storage to the secondary storage may be detected, for example, by determining a signature for each section of the primary storage and comparing the determined signatures with corresponding signatures of the secondary storage. This detection may be advantageous because it allows sending, to the secondary storage, only the content where signatures do not match between the primary and secondary storages. In an embodiment, a signature may be determined, for example, by performing a checksum on a first block of data in the primary storage and comparing it to a checksum performed on the second block of data corresponding to the first block of data in the primary storage.

In a trace, a notification component receives content and an address respective of the content which is stored on the primary storage. The content and address are received continuously as changes are performed on the primary storage. In a partial sync, the primary buffer of the notification component is full. A secondary buffer is utilized which receives an address respective of the content and a content length. The content itself is not stored in the secondary buffer. Prior to the sending of content referenced by the secondary buffer to the secondary storage, additional content is retrieved from the primary storage using the addresses and the lengths stored on the secondary buffer. The additional content is then sent to the secondary storage.

During a full sync or partial sync process, a section is read from the primary storage. Before the content is sent to the secondary storage, a part of the section which was read from the primary storage is modified on the primary storage, and the notification component is updated with the new content. This new content may be sent to the secondary storage before the old content (read directly from the primary storage) is sent. As a result, the older content will reach the secondary storage after the newer content and overwrite it, thereby corrupting the secondary storage. This corruption may be solved by refraining from sending content from the notification component immediately after the notification component is updated. A check is performed to determine if content from the same address has already been read and is waiting to be sent to the secondary storage. If so, the relevant part of the content waiting to be sent is overwritten with the content received from the notification component. Thus, only the updated data is sent to the secondary storage.

During a full sync or partial sync process (or both in parallel), it is often advantageous to know when the secondary storage is consistent. In particular, consistency of the secondary storage may be important when a trace process is performed in parallel. This consistency may be achieved by marking the last used position of the notification component's primary buffer after all of the required sections are read directly (not through the notification component) from the primary storage. After all of the content in the primary buffer up to the last used position is sent to the secondary storage, the secondary storage is considered consistent.

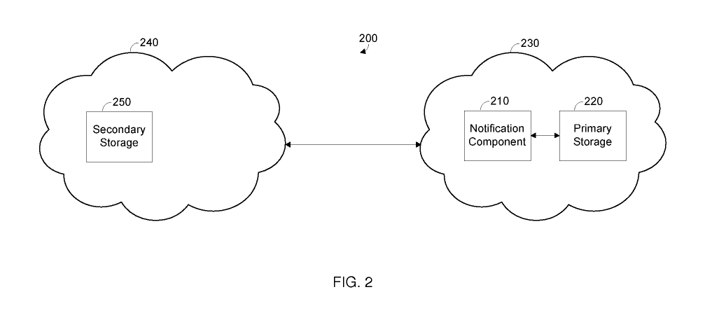

FIG. 2 is an exemplary non-limiting schematic illustration 200 of a notification component 210 in a primary CE 230 communicatively connected to a secondary storage 250 in a secondary CE 240 in accordance with an embodiment. The notification component 210 is communicatively connected to a primary storage 220. The notification component 210 and the primary storage 220 are implemented within the primary CE 230. In certain embodiments, the notification component 210 and the primary storage 220 are implemented on a single machine.

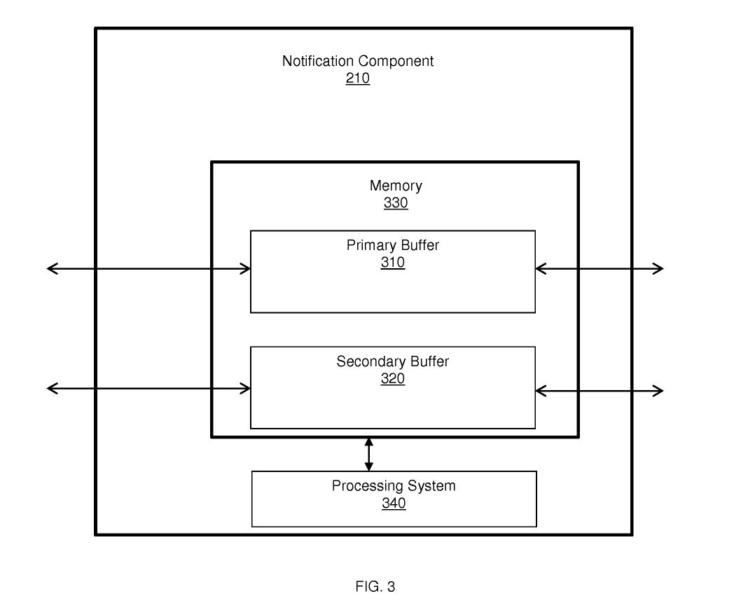

The primary CE 230 is communicatively connected to a secondary CE 240. The secondary storage 250 is implemented within the secondary CE 240. The secondary storage 250 is used to replicate the primary storage 220 as described in more detail herein above with respect to FIG. 1. The notification component 210 further comprises a primary buffer and a secondary buffer. An exemplary and non-limiting notification component is described further herein below with respect to FIG. 3. Each of the buffers may be implemented as a memory which may include volatile memory such as, but not limited to, random access memory (RAM), or non-volatile memory (NVM) such as, but not limited to, Flash memory.

In certain embodiments, the primary and secondary buffers are implemented on a single memory. In such embodiments, the secondary buffer may be used once the free space of the primary buffer drops below a threshold. The threshold may be static, dynamic, or adaptive. Static thresholds are predetermined thresholds that remain constant. Dynamic thresholds are changed throughout operation of the buffers based on changes to storage patterns respective of the primary storage such as, for example, according to rate changes of storage operations that are performed on the primary storage. Adaptive thresholds are changed in response to changes in characteristics of the secondary storage and may vary depending on a variety of parameters.

As a non-limiting example, a static threshold is set such that the secondary buffer is used once the amount of free space on the primary buffer dips below 50 megabytes (MB). As another non-limiting example, a dynamic threshold is set such that the secondary buffer is used if the rate of data being stored to the primary storage exceeds 1 MB/second. As yet another non-limiting example, an adaptive threshold is set that varies based on the amount of storage available in the secondary storage and the stability of the connection between the first storage and the secondary storage.

FIG. 3 is an exemplary and non-limiting schematic diagram of a notification component 210 according to an embodiment. The notification component 210 includes a primary buffer 310, a secondary buffer 320. Each of the buffers 310 and 320 may be implemented as a memory which may include volatile memory such as, but not limited to, random access memory (RAM), or non-volatile memory (NVM) such as, but not limited to, Flash memory. In this embodiment, the primary buffer 310 and the secondary buffer 320 are incorporated on a single memory 330. As a result, one or more thresholds may be utilized to manage storage on the primary buffer 310 and the secondary buffer 320.

In certain embodiments, the notification component 210 includes a processing system 340 configured to determine if one or more of the set thresholds have been reached and the direct the storage to respective buffer based on the thresholds' levels. The processing system 340 can adapt the levels of the dynamic thresholds. Thresholds are described further herein above with respect to FIG. 2.

In certain embodiments, a capacity of the primary buffer 310 is determined by the processing system 340. Upon determining that the primary buffer 310 is at full capacity, information may be stored in the secondary buffer 320. The notification component 210 may further be configured to perform or to be utilized in a trace. In a trace, the notification component 210 receives content and an address respective of the content which is stored on a primary storage (e.g., the primary storage 220). The content and address are received continuously as changes are performed on the primary storage 220.

The processing system 340 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system 340 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing unit, cause the processing unit to perform the various functions described herein.

FIG. 4 is an exemplary and non-limiting flowchart 400 illustrating replication according to an embodiment. In this embodiment, the replication is performed via a full sync, a partial sync, or a trace. In various other embodiments, replication can be performed by a combination of full sync, partial sync, and/or trace. In an embodiment, replication may be performed by a component of a primary computing environment (e.g., the primary computing environment 230) that contains a primary storage (e.g., the primary storage 220). The replication typically causes a secondary storage (e.g., the secondary storage 250) acting as a replica for the primary storage to become consistent with the primary storage.

In S410, a request to make a replica consistent with the primary storage and content that must be replicated are received. In S420, it is checked whether a replica of the primary storage exists and, if so, execution continues with S430; otherwise, execution continues with S440. In S430, it is checked if a primary buffer has available storage space and, if so, execution continues with S440; otherwise, execution terminates. In S440, a trace is performed. Performing a trace is described further herein above with respect to FIG. 1.

In S450, it is checked if a secondary buffer has available storage space and, if so, execution continues with S460; otherwise, execution continues with S470. In S460, a partial sync is performed. Performing a partial sync is described further herein above with respect to FIG. 1. In S470, a full sync is performed. Performing a full sync is described further herein above with respect to FIG. 1.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for asynchronous replication of a storage in a computing environment (CE), comprising:
connecting to a primary storage;
receiving a content and an address respective of the content;
storing, in a designated storage, the content and the address respective of the content; and
sending, from the designated storage, the content and the address respective of the content to a secondary storage, wherein the secondary storage is in a secondary CE.

2. The method of claim 1, further comprising:
determining whether a primary buffer is at full capacity;
upon determining that the primary buffer is not at full capacity, identifying the primary buffer as the designated storage; and
upon determining that the primary buffer is at full capacity, identifying a secondary buffer as a secondary designated storage.

3. The method of claim 2, further comprising:
retrieving content from the primary storage respective of the address and of a content length of the content stored in the secondary buffer; and
sending the content to the secondary storage.

4. The method of claim 3, wherein sending the content to the secondary storage further comprises:
sending the content to a writing component, the writing component communicatively connected to the secondary storage; and
writing, by the writing component, the content to the secondary storage.

5. The method of claim 2, wherein the primary buffer and the secondary buffer are implemented on a single memory.

6. The method of claim 2, further comprising:
storing, in the secondary designated storage, the address respective of the content.

7. The method of claim 6, further comprising:
storing, in the secondary designated storage, a content length respective of the content.

8. The method of claim 2, further comprising:
storing, in the secondary designated storage, a block of the primary storage respective of the content address was changed.

9. The method of claim 8, wherein the secondary designated storage includes at least a bitmap of the primary storage.

10. The method of claim 5, wherein the primary buffer is determined to be at full capacity if a free space of the primary buffer drops below a threshold.

11. The method of claim 10, wherein the threshold is any one of: a static threshold, a dynamic threshold, and an adaptive threshold.

12. The method of claim 1, wherein the content and the address respective of the content are received upon determining that the secondary storage is inconsistent with the primary storage.

13. The method of claim 1, further comprising:
detecting content that needs to be replicated.

14. The method of claim 13, wherein detecting content that needs to be replicated further comprises:
determining a signature for at least one section of the primary storage;
receiving a signature for at least one section of the secondary storage, wherein each received signature corresponds to a determined signature;
determining whether each determined signature matches each corresponding received signature;
upon determining that a determined signature does not match a corresponding received signature, identifying a section associated with the determined signature as part of the detected content.

15. A non-transitory computer readable medium having stored thereon instructions for causing one or more processing units to execute the method according to claim 1.

16. An asynchronous replication system for synchronizing a storage in a computing environment (CE), comprising:
a processing system;
a memory containing instructions that, when executed by the processing system, configure the system to:
connect to a primary storage;
receive a content and an address respective of the content;
store, in a designated storage, the content and the address respective of the content; and
send, from the designated storage, the content and the address respective of the content to a secondary storage, wherein the secondary storage is in a secondary CE.

17. The system of claim 16, wherein the system is further configured to:
determine whether a primary buffer is at full capacity;
upon determining that the primary buffer is not at full capacity, identify the primary buffer as the designated storage; and
upon determining that the primary buffer is at full capacity, identify a secondary buffer as a secondary designated storage.

18. The system of claim 17, wherein the system is further configured to:
retrieve content from the primary storage respective of the address and of a content length of the content stored in the secondary buffer; and
send the content to the secondary storage.

19. The system of claim 17, wherein the primary buffer and the secondary buffer are implemented on a single memory.

20. The system of claim 17, wherein the system is further configured to: store, in the secondary designated storage, the address respective of the content.

21. The system of claim 20, wherein the system is further configured to:
read content from the primary storage, respective of the address stored in the secondary designated storage; and
send, to the secondary storage, the content from the primary storage corresponding to the address.

22. The system of claim 20, wherein the system is further configured to:
determine if an address is stored with more than one timestamp in the secondary designated storage; and
send to the secondary storage the content corresponding to the latest timestamp, upon determination that the address is stored with more than one timestamp in the secondary designated storage.

23. The system of claim 20, wherein the system is further configured to: store, in the secondary designated storage, a content length respective of the content.

24. The system of claim 19, wherein the primary buffer is determined to be at full capacity if a free space of the primary buffer drops below a threshold.

25. The system of claim 24, wherein the threshold is any one of: a static threshold, a dynamic threshold, and an adaptive threshold.

26. The system of claim 16, wherein the content and the address respective of the content are received upon determining that the secondary storage is inconsistent with the primary storage.

27. The system of claim 16, wherein the system is further configured to:
detect content for replication.

28. The system of claim 27, wherein the system is further configured to:
determine a signature for at least one section of the primary storage;
receive a signature for at least one section of the secondary storage, wherein each received signature corresponds to a determined signature;
determine whether each determined signature matches each corresponding received signature;
upon determining that a determined signature does not match a corresponding received signature, identify a section associated with the determined signature as part of the detected content.

29. The system of claim 28, wherein the system is further configured to:
generate a notification respective of at least an address of a section of the detected content to indicate that the secondary storage is inconsistent for the at least an address.

30. The system of claim 28, wherein the system is further configured to:
generate a notification to indicate that the secondary storage is consistent respective of the primary storage, upon determination that the detected content was stored on the secondary storage.

31. The system of claim 28, wherein the system is further configured to: generate a notification to indicate that the secondary storage is consistent respective of the primary storage at a known timestamp, upon determination that the secondary storage is a replication of the primary storage at the known timestamp.
